(19) United States
(12) Patent Application Publication
(10) Pub. No.: US 2007/0011016 A1
(43) Pub. Date: Jan. 11, 2007

(54) Springing interests flowing from benefits that run with land

(76) Inventor: Joseph B. Alderman, Round Rock, TX (US)

Correspondence Address: JOHN BRUCKNER, P.C., P.O. BOX 490, FLAGSTAFF, AZ, 86002, US

(21) Appl. No.: 11/176,724

(22) Filed: Jul. 7, 2005

(51) Int. Cl. G06Q 99/00

(52) U.S. Cl. 705/1

(57) ABSTRACT

Methods are described for transmuting ownership interests in real property by generating springing interests flowing from benefits that run with land. A method includes before a first transfer from an original value-adding owner to a second owner conferring a benefit that runs with at least one piece of real estate; and then attaching a covenant to the at least one piece of real estate, the covenant granting a springing interest that shall vest at a time of one or more subsequent transfers of the at least one piece of real estate in, consideration of the benefit.

### BACKGROUND INFORMATION

1. Field of the Invention

Embodiments of the invention relate generally to the field of real estate transactions. More particularly, an embodiment of the invention relates to springing interests flowing from benefits that run with land.

2. Discussion of the Related Art

A persistent problem with housing is the high price of entry for most new homes. While low interest rates can help ameliorate this problem by lowering the “principle plus interest” present value cost of a new home, it can be presumed that entry level buyers will always face economic barriers to entry. What is needed, therefore, is a business process that helps to make homes more affordable, especially for entry level buyers.

Another persistent problem is that while an owner is generally free to add value to a property (for example, via improvements to the land and/or structures), typically the only way such a “value adder” can be monetarily compensated for such improvements is to increase the asking price of the property when that “value adder” sells. This can lead to a situation where an owner may decide not to add value to a property, especially if a given property is already close to “over-improved” compared to neighboring properties. What is also needed, therefore, is a business process that compensates value adders for the added benefits by providing flexibility with regard to the way in which compensation can be recovered.

Another persistent problem is that when a value-adding owner adds value to real property, the value-adding owner is often unaware that the basis for an independent title interest can be created, and that the independent basis would have rights and value separate from traditional property rights such as traditional surface and subsurface (mineral) rights. What is needed, therefore, is a business process that allows a value adder to sever and capture this independent title right.

U.S. Pat. No. 6,766,322 issued Jul. 20, 2004 to Bell entitled Real Estate Disclosure Reporting Method describes disclosure methods. U.S. Pat. No. 6,615,187 issued Sep. 2, 2003 to Ashenmil et al entitled Method Of Securitizing and Trading Real Estate Brokerage Options describes securitization of brokerage fees. U.S. Pat. No. 6,564,190 issued May 13, 2003 to Dubner entitled Method and Formulating an Investment Strategy for Real Estate Investment describes investment strategies. U.S. Pat. No. 6,292,788 issued Sep. 18, 2001 to Roberts et al entitled Method and Investment Instruments for Performing Tax-Deferred Real Estate Exchanges describes investment strategies for groups of real estate investors involving deeds. U.S. Pat. No. 5,857,174 issued Jan. 5, 1999 to Dugan entitled Real Estate Appraisal Method and Device for Standardizing Real Property Marketing Analysis by Using Pre-adjusted Appraised Comparable Sales describes an appraisal method wherein a points system provides standardization.

US Publication No. 2003/0144943 published Jul. 31, 2003 in the name Zivan entitled Business Method for Deferring the Payment of a Broker's Commission or Fee describes deferral of broker's commissions. US Publication No. 2002/0169622 published Nov. 14, 2002 in the name of Estridge, Jr. entitled Process for Enhancing Development of Real Estate describes development and transfer of easements by the developer. US Publication No. 2002/0040335 published Apr. 4, 2002 in the name of De Veux et al. entitled Maintenance Fee Recovery Program describes home owner's association fees.

Heretofore, the requirements of helping to make homes more affordable and helping value adders recover compensation for improvements by providing flexibility with regard to the way in which compensation can be recovered, referred to above have not been fully met. What is needed is a solution that solves these problems.

### SUMMARY OF THE INVENTION

There is a need for the following embodiments of the invention. Of course, the invention is not limited to these embodiments.

According to an embodiment of the invention, a process comprises: a value-adding owner, before transfer of title to a second owner, conferring a benefit on at least one piece of real estate; the benefit running with the at least one piece of real estate, the value adding owner then attaching a covenant to the at least one piece of real estate, the covenant granting a springing interest that vests in the original value-adding owner or assign in consideration of the benefit, the vested springing interest granting unto the value adding owner or assigns the right to receive a conveyance fee upon each transfer of title made subsequent to recordation of the covenant, and reserving in the first and subsequent transfers a lien securing payment of a conveyance fee, and prior to each transfer subsequent to attachment of the covenant, a prospective owner is provided, with regard to the covenant, with at least one form of notice selected from the group consisting of actual notice and constructive notice, and wherein each subsequent owner is required as a condition of transfer of title to the at least one piece of real estate to provide actual notice of the covenant to subsequent prospective purchasers of the at least one piece of real estate.

According to another embodiment of the invention, a process comprises: a value-adding owner conferring a benefit upon, and that runs with, at least one piece of real estate; and then attaching a covenant to the at least one piece of real estate, the covenant vesting the value adding owner with a springing interest given in consideration of the benefit.

These and other embodiments of the invention will be better appreciated and understood when considered in conjunction with the following descriptions and the accompanying drawings. It should be understood, however, that the following descriptions, while indicating various embodiments of the invention and numerous specific details thereof, are given by way of illustration and not of limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer conception of embodiments of the invention, and of the components combinable with, and operation of systems provided with, embodiments of the invention, will become more readily apparent by referring to the exemplary, and therefore nonlimiting, embodiments illustrated in the drawings. Embodiments of the invention may be better understood by reference to one or more of these drawings in combination with the description presented herein.

FIG. 1 is a flow diagram of a process among parties, representing an embodiment of the invention where a single covenant as embodied under this invention has been recorded.

FIG. 2 is a flow diagram of a process among parties, representing an embodiment of the invention, which expands upon the explanation of the process as described in FIG. 1.

FIG. 3 is a flow diagram of a process among parties, representing an embodiment of the invention where multiple overlapping covenants as embodied under this invention have been recorded by multiple value adders.

FIG. 4 is a block diagram of legal interests in the context of a process, representing an embodiment of the invention.

FIG. 5 is a block diagram of land subject to covenants, liens and contracts, representing an embodiment of the invention.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known techniques are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The below-referenced U.S. Patents and U.S. Patent Applications disclose embodiments that are useful for the purposes for which they are intended. The entire contents of U.S. Pat. Nos. 6,766,322; 6,615,187; 6,564,190; 6,292,788; and 5,857,174 are hereby expressly incorporated by reference herein for all purposes. The entire contents of U.S. Patent Application Publication Nos. 2003/0144943; 2002/0169622; and 2002/0040335 are hereby expressly incorporated by reference herein for all purposes.

The invention can be viewed as a concept for conducting a business transaction. By establishing a “covenant that runs with the land” as part of the “business process” utilizing the “conveyance fee”, the estate held in the land itself can be transmuted. The transmuted estate can be assigned a net present value, giving it a tangible existence of its own.

Although mineral rights are often severed from surface rights, prior to this invention creation and severance of an independent title right, or interest, that springs from benefits that run with the land, which has been created by adding value to the land, has been non-existent, unknown or untapped. The creation of an independent springing interest related to or arising out of a benefit that runs with land has been undiscovered, unknown and unimplemented.

When value is added to land, and when the benefit of the value is ongoing (e.g. “runs with the land”), payment can be demanded, and the right to receipt of the payment can be secured by a covenant that runs with the land. The value that is added, and which gives rise to the ability to grant the springing interest contemplated in this invention, can be tangible (streets, utilities, parks, etc.) or intangible (the “thought” and/or “creativity” that went into the site selection, layout, design, other covenants, sighting of roadways for views, and the general “look and feel” or the subdivision).

Unique characteristics of the system can include (1) a covenant that runs with the land, (2) filed or recorded in favor of a value adding owner, (3) which binds subsequent owners of the land, and (4) which requires periodic payment of a conveyance fee to the value adding owner or assigns. (5) The covenant can require payment of the conveyance fee upon occurrence of a specified event (e.g. transfer of the property), (6) the right to receipt of the conveyance fee can be secured by a lien on the property, (7) the right to ongoing receipt of the conveyance fee can be for any period that does not violate the rule against perpetuities or other applicable statute, law or regulation (8) the right to receipt of the conveyance fee can be for a set number of payments, a designated amount, a percentage of the consideration given for a transfer of title, a given duration in time or the like, (9) specific transfers of title can be exempted from payment of the conveyance fee by provisions of the covenant, (10) the obligation to pay the conveyance fee can include an obligation to provide actual and/or constructive notice to future buyers, (11) the beneficiary of the conveyance fee is preferably not obligated to a future performance and (12) the right to receipt of any future conveyance fee or other interest arising out of the covenant (a springing interest) is an independent right that has value and can be sold independent of title to the land subject to the covenant.

When a covenant is filed, a notice can be filed in the public records, stating, in essence, “Lot 16, Block______ Windermere subdivision is subject to payment of a transfer fee as described in the covenant filed of record in book ______ page ______, real property records of ______ county. Payment should be remitted to ______. The title company will then pick up the covenant language (they should do so without the notice, since the covenant is in the real property records), and will collect, and remit, payment to the value adder or assign. Therefore, as part of the business process, there is no collection activity required. Absent collection of the fee, good title cannot be conveyed. This is an important advantage of embodiments of the invention.

The following are examples of benefits that could give rise to a springing interest secured by a covenant.

A developer who subdivides land into one or more parcels provides intangible benefits to the land by, among other things, determining the lot layout, preparing and recording restrictions governing use of the land, establishing the “views” as well as the “look and feel” of the subdivision as a whole, and by undertaking similar decisions. The Developer may provide tangible benefits to land by installing streets, utilities or similar improvements. The foregoing acts all benefit each and every lot on the land and therefore constitute benefits that “run with the land”. Since such benefits may last for an extended period, a value adder (e.g., a developer), using this invention, can generate a separate title interest, value and ongoing income.

A contractor may provide intangible benefits to land by, among other things, deciding which structure to build and where to locate the structure upon the land. A contractor may tangible benefits to the land by building the structure.

A homeowner may provide tangible benefits to land by, among other things, causing improvements to be made to the land. A homeowner may provide intangible benefits to land by, among other things, deciding where to locate improvements upon the land.

A commercial property owner (“CPO”) may provide tangible benefits to land by, among other things, causing improvements to be made to the land or buildings located thereon. A CPO may provide intangible benefits to land by, among other things, deciding where to locate new improvements upon the land.

The invention can include a method whereby a “value adder” (such as a property owner who carries out improvements to the land) can offset all or part of the costs of such benefits to the land through an ongoing fee arrangement binding all later transferors of the land. The invention can include a method by which a developer might forego a portion of the sale price of a real property in favor of later income from the property. The invention can include a method by which a developer may be assured, based upon conferred benefits touching and concerning the land, of a continuing financial stake after the time of development. The invention can include a method by which a developer can defer compensation for the cost of improvements such as structures, utilities, additions, etcetera in exchange for later consideration based on one or more springing interests flowing from benefits that run with the land. The invention can include a system by which a developer may retain rights in property earlier sold. The invention can include legal structures and devices allowing a conveyance fee that is tied to one or more benefits that run with a given piece of land.

The invention can include a method, wherein after a developer, person, firm or other entity (value adder) has added value, tangible or intangible, to real estate (for example, during the subdivision process, while owning an individual residence or commercial property, etcetera), that value adder” may encumber the land with a covenant running with the land requiring payment, repayment, or the like in consideration for this value in the form of compensation paid whenever the property is transferred. Benefits such as a reduced sales price, intangible planning and design, tangible physical improvements and so on may all be relied upon as consideration in this way.

Such individuals are referred to herein as “value adders”, “original owners”, “developers” and by other related terms. Note that technically a developer is a specific type of commercial entity and that an “original” owner is an individual who obtained the land from another but added value thereto. All such entities are covered by these terms.

The invention can include a process wherein a conveyance fee may be made part of a covenant before or during transfer of real estate, the conveyance fee stipulating that later transfers require payment of the fee to the original value adder or their assignee(s). The covenant may relate to a benefit that runs with the land. The conveyance fee may be secured by a lien, and may be attached by a developer value adder to each lot in a subdivision. The second party/purchaser and/or the third party/purchaser and/or subsequent party purchaser(s) of the land may be obligated to pay the conveyance fee. The conveyance fee may be levied for a period of years. If applicable, the time period during which the conveyance fee is levied should not violate the rule against perpetuities.

The obligation to pay the conveyance fee may be held in abeyance by operation of the covenant (e.g. transfer from second owner to a third owner could be exempted from payment of the fee). Later transfers (e.g., from the third owner to the fourth owner, and all subsequent transfers) could then be subject to the covenant and require payment of the conveyance fee.

Although in its preferred embodiment the invention contemplates that the conveyance fee will be a percentage of the consideration paid in connection with each transfer of title, for a given number of years, this contemplation is not limiting: the covenant may require payment of the conveyance fee as a series of payments, as a designated amount, as a percentage of price, or other terms of price, term and/or schedule as set (defined) by a particular embodiment of the invention.

The covenant, and obligation to pay the conveyance fee, may be of perpetual duration (to the extent allowed by applicable law), or may be subject to limitation to a set number of transfers, a total fee to be recovered, a given time duration, or the like. It may include an obligation to provide actual or constructive notice to future buyers and may be payment for past benefits previously conferred on the land, without requiring additional future performance with regard to the consideration for the conveyance fee, provided that those past benefits run with, touch and/or concern the land.

Thus, the conveyance fee may be calculated as a percentage of the value of the land (including improvements or not), or may be a single flat fee at each transfer, or may be a function of the benefit to the land which the value adder (e.g., developer, individual home owner, etcetera) originally and/or later provided.

The invention can include a method of selling real estate by an original owner, the method comprising: providing at least one piece of real estate for first transfer to a second owner; and providing a covenant on the real estate prior to the first transfer but subsequent to benefits having been conferred upon the real estate, the covenant running with the land and providing that a conveyance fee shall be paid to the original owner or assign at the time of one or more subsequent transfers of the real estate.

According to an embodiment of the invention, a process comprises: before a first transfer from an original value-adding owner to a second owner, the value adding owner having conferring a benefit on or to at least one piece of real estate, whether by (a) developing the at least one piece of real estate, (b) building upon the at least one piece of real estate or (c) otherwise directly or indirectly improving the at least one piece of real estate; the benefit running with the at least one piece of real estate; then attaching a covenant to the at least one piece of real estate, the covenant, in consideration of the benefit, vesting the original value adding owner with (i) a springing interest and (ii) the right to receive a conveyance fee upon occurrence of one or more subsequent transfers of the at least one piece of real estate; and reserving in the covenant, deed or both, a lien securing payment of a conveyance fee; and wherein prior to each transfer a prospective owner is provided, with regard to the covenant, with at least one form of notice selected from the group consisting of actual notice and constructive notice, and wherein each owner subsequent to the value adding owner is required as a condition of acceptance of the deed or title to the at least one piece of real estate, to provide actual notice of the covenant to a subsequent owner at the time of sale or transfer.

The invention can include a method of selling real estate wherein the conveyance fee is paid in whole or in part by the grantor, grantee or third party(ies). The invention can include a method of selling real estate wherein at least the first transfer is a purchase. If permitted or required in a given jurisdiction, the invention can include a method of selling real estate wherein the purchase price of the first transfer is reduced as the legal consideration for the covenant. The invention can include a method of selling real estate wherein the second owner is provided prior to the first transfer with notice, the notice being at least one member selected from the group consisting of: actual notice or constructive notice. The invention can include a method of selling real estate wherein each owner subsequent to the value adding owner is required as a condition of a transfer of title to agree to provide notice of the covenant to a prospective subsequent owner, prior to transfer of title. The invention can include a method of selling real estate further comprising: reserving in connection with the first transfer, whether by reservation within a deed, a deed of trust, separate instrument or otherwise, a lien enforceable through legal or arbitration proceedings, the lien securing payment of the conveyance fee and/or obligations under the covenant. The invention can include a method of selling real estate wherein the at least one piece of real estate comprises two or more lots. The invention can include a method of selling real estate further comprising: applying the conveyance fee against previous benefits to the real estate. The invention can include a method of selling real estate further comprising: adding value to the real estate. The invention is equally suitable for all types of real estate, including but not limited to residential, commercial, industrial, office, retail, historical and other types of real estate. The invention can include a method of selling real estate further comprising one member selected from the group consisting of: improving the individual parcel of real estate, developing at least one parcel of the real estate, building upon the real estate, and combinations thereof. The invention can include a method of selling real estate further comprising subdividing the real estate. The invention can include a method of selling real estate wherein the original value-adding owner adds improvements to an existing structure on the property. The invention can include a method of selling real estate wherein the improvements comprise a new structure.

The invention can include making a conveyance fee part of a covenant during a transfer of real estate, the conveyance fee stipulating that later transfers require payment of the fee to the original owner of the real estate. The conveyance fee may be stipulated in a covenant and should be related to a benefit that runs with, touches and/or concerns the land. The conveyance fee may be secured by a lien, and may be attached by a developer to each lot in a subdivision. The original sale price of the land may be reduced as legal consideration for the imposition of the conveyance fee.

### EXAMPLE

A specific embodiment of the invention will now be further described by the following, nonlimiting example which will serve to illustrate in some detail various features. The following example is included to facilitate an understanding of ways in which an embodiment of the invention may be practiced. It should be appreciated that the example which follows represent an embodiment discovered to function well in the practice of the invention, and thus can be considered to constitute a preferred mode for the practice of the invention. However, it should be appreciated that many changes can be made in the exemplary embodiment which is disclosed while still obtaining like or similar result without departing from the spirit and scope of an embodiment of the invention. Accordingly, the example should not be construed as limiting the scope of the invention.

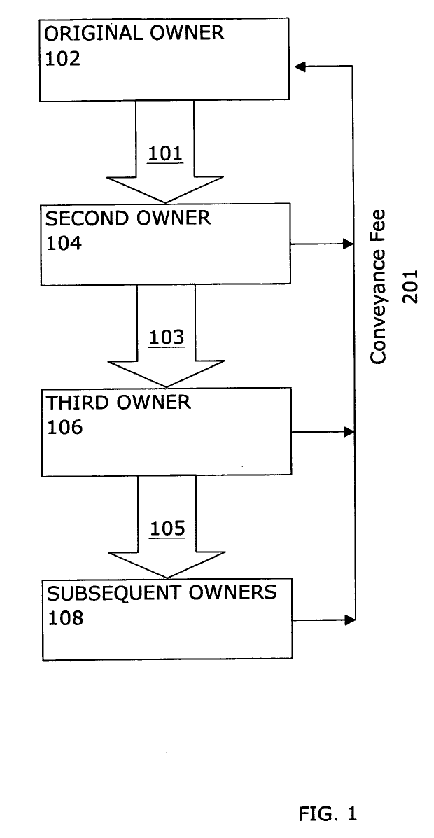

FIG. 1 is a block diagram of the parties of the invention. An original owner 102 and a second owner 104 may represent, as in the best mode now contemplated and the presently preferred embodiment, a developer and a first purchaser of a lot within the development. However they may represent any two parties in any situation in which a covenant as contemplated under this invention may be legally made to run with the land. For example a builder or an individual homeowner may improve the land and add a covenant thereto. Any “value adder” may take the place of the original (value-adding) owner 102. A third owner 106 may be a second purchaser of the real estate from the second owner 104. A first transfer 101 may include a sale and purchase of a vacant lot, while a second transfer 103 may include a sale and purchase of the lot with a new home located thereupon. In alternative embodiments, the transfers may include without limitation transfers by gift, death, and various legal proceedings such as foreclosure proceedings and the like.

In a simple mode of the invention, a conveyance fee 201 may accrue to the benefit of original owner 102 at the time of the first transfer from the first value adding owner 102 to the second owner 104, and again at the time of the second transfer 103 from the second owner 104 to the third owner 106, and again at the time of the third transfer 105 from the third owner 106 to subsequent owner 108, and continuing for each subsequent transfer made during the term of the covenant. Conveyance fee 201 may be in consideration for improvement(s) that touch and concern the land. Conveyance fee 201 may also commonly bind a number of pieces of real estate, for example, the lots of a subdivision/community. In alternative embodiments, the conveyance fee 201 may include a portion that is in consideration for a lower sales price charged by the first owner 102 to the second owner 104, thus providing a community benefit by increasing the accessibility of the community to those second owners 104. In alternative embodiments, one or more transfers could be exempted, by the terms of the covenant, from assessment of the conveyance fee (e.g. transfer from original owner 102 to second owner 104 could be exempted from payment of the fee.)

The first owner 102 may be a developer who has subdivided, developed, or otherwise added value to the real estate. For instance, the unique design characteristics, improvements and/or amenities provided by the developer provide ongoing benefits to subsequent owners of the land and serve as consideration for the conveyance fee covenant. In alternative embodiments, the first owner 102 may be a builder adding new homes or other new structures and/or the like to the land, which provide ongoing benefits to subsequent owners of the land and serve as consideration for the conveyance fee covenant. In yet other alternative embodiments, the first owner 102 may be an individual homeowner adding improvements to already existing structures, renovations, or rehabilitation, which provide ongoing benefits to subsequent owners of the land and serve as consideration for the conveyance fee covenant. All such first owners are original value-adding owners for the purposes of the invention.

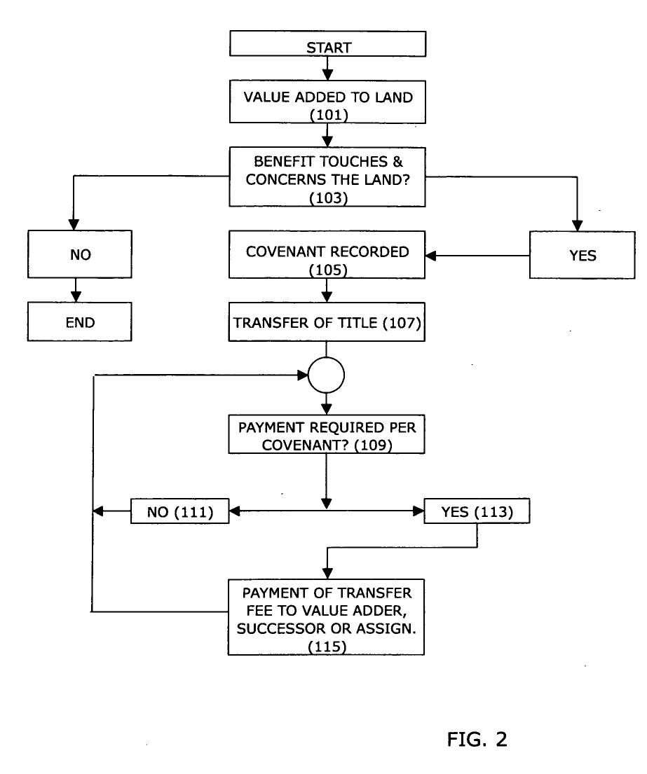

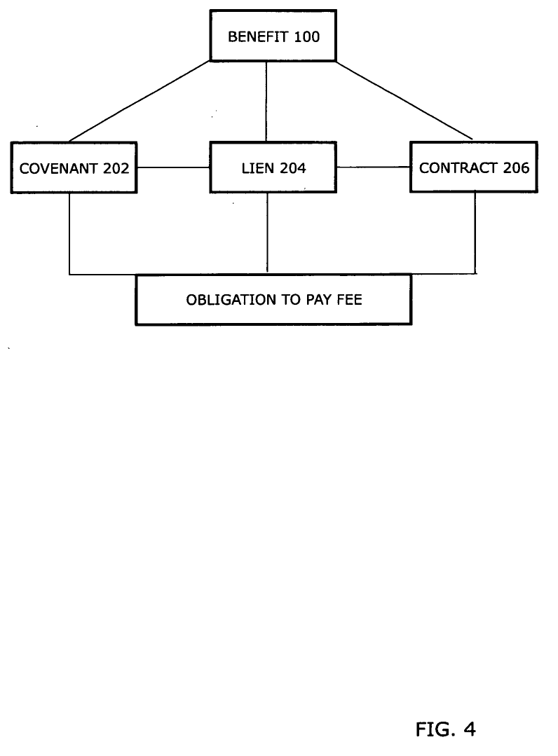

FIG. 2. is a block diagram of an example of a process related to the invention. When value is added to land (101), where the benefit touches and concerns the land (102), a covenant as contemplated under the invention can be recorded (105). Upon transfer of title (107), where the covenant so requires (109, 113), a transfer fee shall be paid (115). If the transfer is exempt from payment of the covenant (109, 111) then subsequent transfers are re-examined (109). It is important to note that under the current embodiment of the invention, the covenant recordation can include contemporaneous recordation or reservation of contract rights and/or lien rights related to the current embodiment of the invention (See FIG. 4).

In FIG. 2, the ability to grant the springing interest by attaching the covenant arises at 101 when benefit is conferred upon land, and when the benefit touches and concerns the land (103). A person can benefit the land, and have the interest arise, without selling the land. The covenant is recorded at 105. Title is transferred at 107, thereby vesting the springing interest. It is important to note that the “interest” as embodied under this invention does not arise at the time of a transfer, it arises when the benefit is conferred. A determination is made at 109 of whether payment is required by the covenant. At 115, the conveyance fee is paid to the value adder or their successor or assign.

The device of the invention may be created by reciting language such as:
“Within, and for the benefit of, the subdivision and the Lots therein, Declarant has created a master subdivision plan, set aside parkland and common areas, and constructed streets, drainage and other improvements, (jointly and severally “Improvements”), which a party taking possession of any Lot stipulates all and singularly benefit said Lot. In consideration therefore, the Owner of any Lot in the development (“Owner”), by acceptance of a Deed therefore, whether or not it shall be express in the Deed, and for the foregoing benefits and other good, valuable and independent consideration, receipt of which is acknowledged by acceptance of the Deed, and as a covenant running with the land, is deemed to covenant, agree and shall be obligated to pay Declarant or assign(s), upon each transfer of title to a Lot in the Subdivision, a “Conveyance fee” equal to one percent of the Gross Sales Price of the Lot (including any improvements thereon). No Conveyance fee shall be levied upon the transfer of a Lot (a) by the Declarant; (b) by a Builder; (c) by a co-Owner of a Lot to a person or entity who was a co-Owner of the Lot immediately prior to such transfer; (d) by a Grantor to any entity wholly owned by Grantor; provided, upon any subsequent transfer of any ownership interest in such entity, a Conveyance fee shall become due; (e) by an institutional lender pursuant to a mortgage that is superior to Declarant's lien or upon foreclosure of a mortgage that is superior to Declarant's lien; (i) for transfers made on or before the first occurrence of (i) Jan. 1, 2010 or (ii) completion of improvements on ninety percent of the total Lots within the subdivision (g) if the Lot being conveyed is unimproved. For purposes hereof, the term “Builder” refers to a person or entity who purchases a Lot in the Subdivision from Declarant for the purpose of constructing a residential dwelling thereon and who is regularly engaged in the business of constructing homes for sale to individuals, and the term “Gross Selling Price” of a Lot shall mean the total consideration paid by the purchaser of the Lot, as is (or ordinarily would be) indicated on the title company's closing statement or, if a contract for deed or similar instrument, as indicated in the contract for deed or similar instrument, including consideration paid for all improvements on the Lot.”

This will function to tie the obligation to the land (“run with the land”). Thus, the invention can include a valid interest in real estate that runs with the land so burdened (encumbered). The printed matter above is a legal instrument which merely creates such the interest of the invention, this language is not the real estate interest of the invention.

It is important to note that under the current embodiment of the invention a single piece of real estate can become subject to more than one covenant.

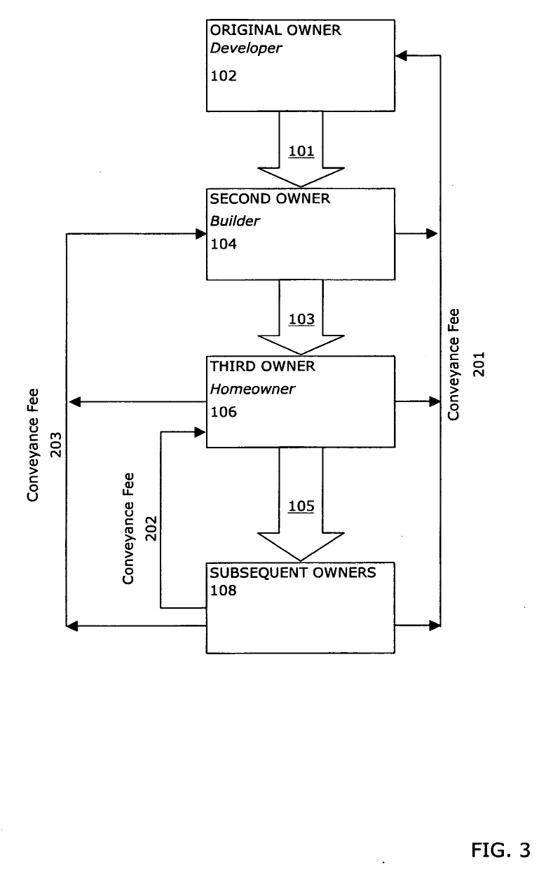

FIG. 3 is a block diagram of the parties of the invention, showing overlapping covenants. In example, if original owner 102 is a developer who adds value, and records a covenant requiring payment of conveyance fee 201, upon transfer 101 second owner 104 would be obligated to pay conveyance fee 201 to original owner 102. However, if second owner 104 is a homebuilder who also adds value to the land, and records a covenant requiring payment of a conveyance fee 203, then upon transfer 103 third owner 106 (and all subsequent transferee's) might be obligated to pay conveyance fee 201 to original owner 102 and conveyance fee 203 to second owner 104. In this example, if third owner 106 is a homeowner who further improves the property (in example, by adding an addition to the home), and files a covenant requiring payment of conveyance fee 202, then subsequent owners 108, upon transfer 105, would owe conveyance fee 201 to original owner 102, conveyance fee 203 to second owner 104 and conveyance fee 202 to third owner 106, a total of three separate conveyance fees paid to three separate parties. The foregoing is given in way of example of an embodiment of the invention, and not in limitation thereof.

FIG. 4 is a block diagram of the real estate interests of the invention. When a benefit is conferred upon land, the right to compensation arising out of that benefit can be jointly and severally secured by Covenant (202), Lien (204) and Contract (206). Contract 206 may represent alternative and/or further interests in the real estate upon which benefit 100 was conferred by mandating the conveyance fee of the invention, setting terms of the transfer such as price, reciting consideration, requiring notice be given by one party to another, and so on. For example in addition to a lien (204) and covenant interest (202) in the land, the invention may also comprise a contractual right (206) to payment of the conveyance fee, thus allowing the original owner to manage their legal rights not just as liens but also, if necessary and for some reason desirable, as contract rights. The conveyance fee may run with the land in covenant and also bind transferees (Buyers) in contract. However, since in some circumstances contract rights may be extinguished (bankruptcy, for example) when the covenant would continue to run with the land, preferred embodiments of the invention do not rely strictly upon contract provisions.

Lien 204 is an additional interest in the land which may be considered to be passive (dormant) and not to be used except in the event of violation of the terms of the contract(s) and/or covenant(s) on an individual piece of real estate. Such rights in lien may then be used in legal or administrative proceedings to induce payment of the conveyance fee.

Language as the following example may create such lien rights:
In order to secure payment of the Conveyance fee a vendor's lien for the benefit of the declarant shall be and is hereby reserved in the Deed from Declarant to the purchaser of each Lot or portion thereof, which lien shall be enforceable through appropriate judicial or nonjudicial proceedings. As additional security for payment of the Conveyance fee, each Owner of a Lot in the Subdivision, by such party's acceptance of a deed thereto, hereby grants Declarant a contractual lien on such Lot which may be foreclosed pursuant to the law, and each such Owner expressly grants Declarant a power of sale in connection therewith.

The declarant of the original covenants (normally the developer of the subdivision) may in turn transfer these rights in covenant, lien and/or contract to yet another party, thus functionally allowing the developer to sell the right to receive conveyance fees.

Notice that such interests are NOT merely printed matter. On the contrary, an interest in real estate can and often does survive the destruction of the legal instruments creating that interest. A typical example of this is when land records are destroyed in courthouse fires and the like, the ownership interests of the individual landowners in the impacted county do not cease to exist: the ownership interests, mortgage interests, liens, covenants and so on are real world interests which survive destruction of any printed legal instruments creating them. The real estate interest of the invention, the right to receive the conveyance fee, is likewise not mere printed mater. The invention, which allows severing of the springing interest, can create yet another tier of ownership rights in land, just as “mineral rights” can be owned separate from “surface rights”.

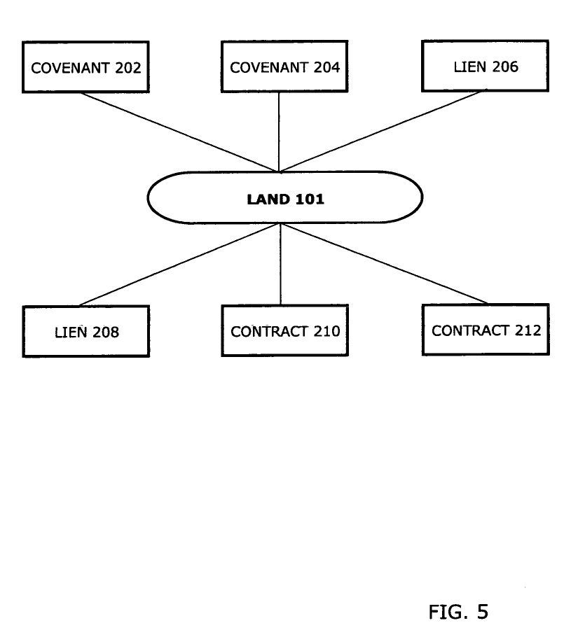

A wide variety of interests may touch and concern land subject to one or more covenants as embodied in this invention. As shown in the non-limiting example in FIG. 5, Land 101 can be subject to (a) Covenant 202, which may represent usual and customary deed restrictions, (b) Covenant 204, which may represent a covenant as embodied under this invention, (c) Lien 206, which may represent a mortgage related lien, (d) Lien 208, which may represent a lien securing obligations under Covenant 204, (e) Contract 210, which may represent a promissory note, deed of trust or similar contracts and (f) Contract 212, which may represent contract rights related to the invention. The invention is compatible with (can be practiced in the presence of) homeowner associations.

In regulatory environments in which perpetual interests are not allowed (for example, should the rule against perpetuities or local regulations of similar type be imposed against the invention) the invention may be limited in duration and scope. In regulatory environments where perpetual interests are allowed, the conveyance fee can defined to be (considered to be) perpetual subject only to later judicial or regulatory action.

The obligation to pay the conveyance fee according to the invention may be limited to a number of transfers, total dollars paid or the like. The conveyance fee may be calculated as a percentage of the value of, or consideration given for, the land (including improvements or not), or may be a single flat fee at each transfer, or may be a function of the benefit to the land upon which the conveyance fee is based. In the presently preferred embodiment, a fee of one percent of the value of the land at the time of transfer (including improvements and fixtures) can be used. Other percentages may be used, ranging from very small fraction of the value of the land to larger percentages of the value of the land. The interests in real estate which may be so burdened by the covenant of the invention may include not just ownership in fee simple but also long term leases, condominium ownership interests, and other similar real estate interests.

### Definitions

The terms “land”, “real estate”, “property” and “real property” all refer to real property. The term “benefit” means to improve or to enhance in value, whether directly or indirectly. The phrases “running with land” and “runs with the land” means goes with the land, as being annexed to the estate, and which cannot be separated from the land itself. As used herein, a benefit is said to “run with the land” when the benefit is continuing and enhances the land. The term “conveyance fee” is intended to mean consideration due in return for a benefit previously conferred upon, and which runs with, real property (in example, compensation paid in partial payment for previous improvement to a piece of real estate). The term “springing interest” is intended to mean a future interest subject to a condition subsequent or precedent (e.g., a right to receive a conveyance fee upon each transfer of ownership of a piece of real estate). The term “covenant” means a legal document, usually filed of record, which sets out an obligation that runs with the land and which imposes a burden upon subsequent purchasers to do an act or deed (e.g. pay a conveyance fee as directed within the covenant). As used herein, a covenant is said to “run with the land” when either the liability to perform the terms of the covenant, or the right to take advantage of benefits granted under the covenant, passes to the assignee of that land. The terms “value adder”, “original owner” and “value adding owner” refer to the owner of an at least one piece of real estate who directly or indirectly benefits the at least one piece of real estate (in example, value can be added by constructing improvements upon or to the at least one piece of real estate, developing the at least one piece of real estate through a typical subdivision process, making design decisions regarding improvements to the at least one piece of real estate, and similar common undertakings that can benefit real property). The term “transfer” means to convey or transfer title or ownership. The term “transmuted” means to change from one form or state to another. The term “improvement” or “value” means undertaking any act, decision, or deed that adds value to, ameliorates a condition on, or otherwise benefits the land, and usually costing labor or capital and having as its intention the enhancement of the tangible or intangible value of the land.

The term “substantially” is intended to mean largely but not necessarily wholly that which is specified. The term “approximately” is intended to mean at least close to a given value (e.g., within 10% of). The term “generally” is intended to mean at least approaching a given state. The term “coupled” is intended to mean connected, although not necessarily directly, and not necessarily mechanically. The term “proximate”, as used herein, is intended to mean close, near adjacent and/or coincident; and includes spatial situations where specified functions and/or results (if any) can be carried out and/or achieved. The term “deploying” is intended to mean designing, building, shipping, installing and/or operating.

The terms “first” or “one”, and the phrases “at least a first” or “at least one”, are intended to mean the singular or the plural unless it is clear from the intrinsic text of this document that it is meant otherwise. The terms “second” or “another”, and the phrases “at least a second” or “at least another”, are intended to mean the singular or the plural unless it is clear from the intrinsic text of this document that it is meant otherwise. Unless expressly stated to the contrary in the intrinsic text of this document, the term “or” is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms “a” or “an” are employed for grammatical style and merely for convenience.

The term “plurality” is intended to mean two or more than two. The term “any” is intended to mean all applicable members of a set or at least a subset of all applicable members of the set. The term “step”, when followed by the term “for” is intended to mean a (sub)method, (sub)process and/or (sub)routine for achieving the recited result.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. The terms “consisting” (consists, consisted) and/or “composing” (composes, composed) are intended to mean closed language that does not leave the recited method, apparatus or composition to the inclusion of procedures, structure(s) and/or ingredient(s) other than those recited except for ancillaries, adjuncts and/or impurities ordinarily associated therewith. The recital of the term “essentially” along with the term “consisting” (consists, consisted) and/or “composing” (composes, composed), is intended to mean modified close language that leaves the recited method, apparatus and/or composition open only for the inclusion of unspecified procedure(s), structure(s) and/or ingredient(s) which do not materially affect the basic novel characteristics of the recited method, apparatus and/or composition.

Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting. Although embodiments of the invention can be implemented as a separate sub-system, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be combined in the disclosed arrangements, but could be combined in any and all arrangements.

It can be appreciated by those of ordinary skill in the art to which embodiments of the invention pertain that various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
before a first transfer from an original value-adding owner to a second owner, conferring a benefit on at least one piece of real estate; then
attaching a covenant to the at least one piece of real estate, the covenant granting a springing interest that shall vest in the original value-adding owner at a time of one or more subsequent transfers of the at least one piece of real estate in consideration of the benefit, the vested springing interest including a right to receive a conveyance fee, the benefit i) running with the at least one piece of real estate and ii) including at least one improvement to the at least one piece of real estate selected from the group consisting of developing the at least one piece of real estate and building upon the at least one piece of real estate; and
reserving in the first transfer a lien securing payment of a conveyance fee,
wherein prior to each transfer a prospective owner is provided, with regard to the covenant, with at least one form of notice selected from the group consisting of actual notice and constructive notice, and
wherein the second owner is required as a condition of the first transfer to provide actual notice of the covenant to a third owner.

2. The method of claim 1, wherein the springing interest is assignable and the springing interest vests upon second and subsequent transfers for a period of years that does not exceed the rule against perpetuities.

3. The method of claim 1, wherein the benefit includes improving an existing structure on the at least one piece of real estate.

4. The method of claim 1, wherein the benefit includes building a new structure on the at least one piece of real estate.

5. The method of claim 1, further comprising obtaining ownership of the at least one piece of real-estate by the original value-adding owner before conferring the benefit.

6. The method of claim 1, further comprising obtaining permission of the original value-adding owner before conferring the benefit.

7. A method, comprising:
before a first transfer from an original value-adding owner to a second owner conferring a benefit that runs with at least one piece of real estate; and then
attaching a covenant to the at least one piece of real estate, the covenant granting a springing interest that shall vest at a time of one or more subsequent transfers of the at least one piece of real estate in consideration of the benefit.

8. The method of claim 7, wherein the springing interest vests in favor of the original value-adding owner, the springing interest is assignable, and the springing interest vests upon second and subsequent transfers for a period of years that does not exceed the rule against perpetuities.

9. The method of claim 7, wherein the vested springing interest includes a right to receive a conveyance fee paid by the second owner.

10. The method of claim 7, wherein the vested springing interest includes a right to receive a conveyance fee paid by the third owner.

11. The method of claim 7, wherein the first transfer is a purchase.

12. The method of claim 7, wherein prior to the first transfer the second owner is provided, with regard to the covenant, with at least one form of notice selected from the group consisting of actual notice and constructive notice.

13. The method of claim 12, wherein the second owner is required as a condition of the first transfer to provide actual notice of the covenant to the third owner.

14. The method of claim 7, further comprising reserving in the first transfer a lien enforceable through at least one member selected from the group consisting of legal proceedings, equitable proceedings, and arbitration, the lien securing payment of a right to receive a conveyance fee that vests with the springing interest.

15. The method of claim 7, wherein the at least one piece of real estate includes at least two lots.

16. The method of claim 7, wherein the benefit runs with the at least one piece of real estate.

17. The method of claim 16, wherein the benefit includes at least one member selected from the group consisting of improving the at least one piece of real estate, developing the at least one piece of real estate and building upon the at least one piece of real estate.

18. The method of claim 16, wherein the benefit includes subdividing the at least one piece of real estate.

19. The method of claim 16, wherein the benefit includes improving an existing structure on the at least one piece of real estate.

20. The method of claim 16, wherein the benefit includes building a new structure on the at least one piece of real estate.

21. The method of claim 1, further comprising obtaining ownership of the at least one piece of real-estate by the original value-adding owner before conferring the benefit.

22. The method of claim 1, further comprising obtaining permission of the original value-adding owner before conferring the benefit.
